(19) United States
(12) Patent Application Publication
(10) Pub. No.: US 2005/0264018 A1
(43) Pub. Date: Dec. 1, 2005

(54) Grappling assembly for excavating machines and the like

(76) Inventor: David C. Cummings, Crouse, NC (US)

Correspondence Address: Peter N. Lalos;Stevens, Davis, Miller & Mosher, LLP, Suite 850, 1615 L Street, NW, Washington, DC, 20036-5622, US

(21) Appl. No.: 10/852,484

(22) Filed: May 25, 2004

(51) Int. Cl. B60P 3/00

(52) U.S. Cl. 294/88; 294/104

(57) ABSTRACT

An arm member mountable on a dipper stick of a machine and cooperative with an implement pivotally connected to the dipper stick for grappling articles between the arm member and the implement when the implement is pivoted towards the arm member generally consisting of an upper arm section pivotally connectable to an underside of the dipper for pivotal movement about a first axis substantially parallel to the pivot axis of the implement, a lower section connected to the upper section for pivotal movement relative to the upper section about a second axis lying in a plane disposed substantially perpendicular to the first axis, a mechanism interconnecting the arm sections for biasing the arm sections into longitudinal alignment with each other, including means for retarding the biasing action thereof, and means for suspending the free end of the lower arm section from the underside of the dipper stick, cooperable with such implement when such implement is pivoted toward the suspension means for grappling articles therebetween.

This invention relates to an assembly mountable on a machine, cooperative with an implement also mounted on the machine for grappling articles therebetween such as tree trunks, tree limbs, rocks and the like.

### BACKGROUND OF THE INVENTION

In the prior art, there has been developed an assembly mountable on the dipper stick of a machine, having an implement pivotally mounted thereon, in which the dipper stick and the implement may be maneuvered to grapple articles between the assembly and the implement. Generally, such an assembly, commonly referred to as a “thumb,” consists of an arm member pivotally connected to the underside of a dipper stick of a machine and a chain connected at one end to the underside of the dipper stick and at an opposite end to the free end of the arm member so that when the chain is fully extended and positioned against the near side of an article to be grappled, the implement, usually an excavating bucket, may be curled to grip the article between the chain and implement, allowing the article to be lifted, transported to a selected site and deposited.

In the use of such assemblies, it has been found that in swinging the front end assemblies of machines equipped with such arm members, such members often are caused to strike objects which has resulted in breaking or distorting them. To overcome such breakage or distortion, such arm members have been constructed in a manner to permit them to yield to the application of lateral loads and to be biased back into alignment with the cooperating implement. Although such yieldable constructions have been effective in preventing breakage and distortion of such members, the alignment mechanisms employed often have been found to be comparatively complicated in design and relatively expensive to manufacture. Accordingly, it is the principal object of the present invention to provide an arm member of the type described which not only is effective in service and resistant to breakage and distortion but comparatively simple in design and relatively inexpensive to manufacture.

### SUMMARY OF THE INVENTION

The principal and other objects of the present invention are achieved by the invention by providing an arm member mountable on a dipper stick of a machine and cooperative with an implement pivotally connected to the dipper stick for grappling articles between such arm member and such implement when the implement is pivoted toward the arm member, generally consisting of an upper section pivotally connectable to the underside of the dipper stick for pivotal movement about a first axis, substantially parallel to the pivot axis of the implement, a lower section connected to the upper section for pivotal movement relative to the upper section about a second axis lying in a plane disposed substantially perpendicular to the first axis, means interconnecting the upper and lower arm sections for biasing the arm sections into longitudinal alignment with each other below the dipper stick, including means for retarding the biasing action thereof, and means suspending from the underside of the dipper stick to a free end of the lower arm section, cooperable with the implement when pivoted toward such suspending means for grappling articles therebetween. Preferably, the biasing means comprises a spring and the retarding means includes a cylinder filled with a fluid and a piston having a head portion displaceable in such cylinder, provided with restricted passageways therethrough equipped with one-way valves. The means suspending the free end of the arm member typically would consist of a chain and the arm member would have a length sufficiently short so that when the arm member is mounted on the dipper stick and the implement consists of an excavating bucket adapted to be curled and uncurled to perform digging operations, such chain will permit the arm member to dangle freely from the dipper stick and be received within the bucket and thereby not interfere with the digging operation.

### BRIEF DESCRIPTION OF THE DRAWINGS

FIG. 1 is a side elevational view of the front end assembly of an excavating machine, embodying the present invention;

FIG. 2 is a side elevational view of the front end assembly shown in FIG. 1, illustrating the dipper stick in a retracted position and the bucket in a fully curled position, completing an earth scooping maneuver, further illustrating the free end of the arm member thereof received within the bucket;

FIG. 3 is an enlarged, rear view of the assembly for suspending the free end of the arm member;

FIG. 4 is an enlargement of the connection of one of the suspension means consisting of a chain, to a bracket provided on the free end of the arm member;

FIG. 5 is an enlarged, perspective view of the arm member shown in FIGS. 1 and 2;

FIG. 6 is a top plan view of the arm member shown in FIG. 5; and

FIG. 7 is a side elevational view of the arm member shown in FIGS. 5 and 6.

### DETAILED DESCRIPTION OF THE PREFERRED EMBODIMENT OF THE INVENTION

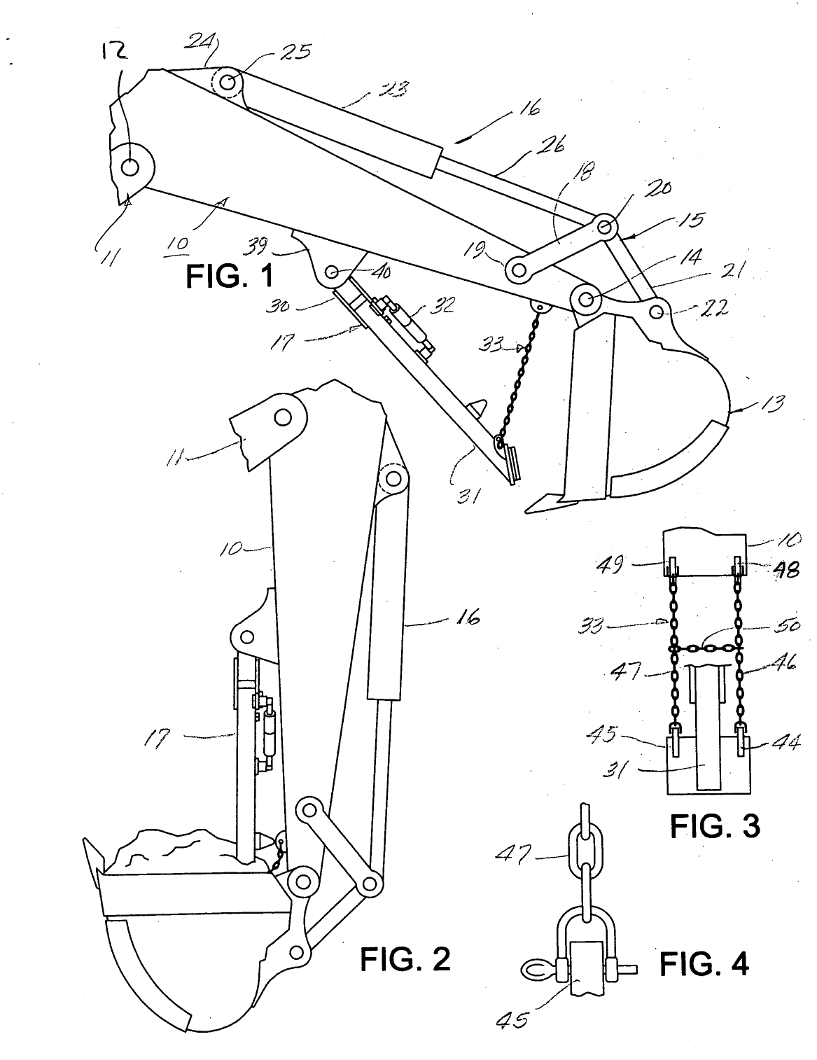

Referring to FIGS. 1 and 2 of the drawings, there is shown a front end assembly of an excavating machine, embodying the present invention. The front end assembly includes a dipper stick 10 pivotally connected to a boom 11 by means of a connecting pin 12, a bucket 13 pivotally connected to the free end of the dipper stick by means of a connecting pin 14, a linkage 15, a fluid actuated cylinder assembly 16 and an arm member 17. In the conventional manner, the lower end of boom 11 is pivotally connected to the main frame of the machine and is adapted to be lifted and lowered by a fluid actuated cylinder assembly. Dipper stick 10 similarly may be pivoted about the axis of connecting pin 12 by means of a fluid actuated cylinder assembly operatively interconnecting the boom and a rear end of the dipper stick. Linkage 15 includes a pair of support links 18, 18 pivotally connected at one set of ends to the side walls of the dipper stick by means of pins 19, 19 and pivotally connected at an opposite set of ends to a connecting pin 20, and a pair of tilt links 21, 21 pivotally connected at one set of ends to connecting pin 20 and at an opposite set of ends to bucket 13 by means of a connecting pins 22, 22 spaced from and parallel to connecting pin 14. Cylinder assembly 16 includes a cylinder member 23 pivotally connected at its base end to a set of brackets 24, 24 mounted on the upper side of the dipper stick by means of a connecting pin 25 and a rod member 26 pivotally connected at its free end to connecting pin 20. It will be appreciated that the boom, dipper stick and bucket may be operated in the conventional manner and the front end assembly of the machine may be swung to perform conventional digging operations, and further cooperate with arm assembly 17 to grapple, transport and deposit various articles such as tree trunks, tree limbs and the like in a manner as hereinafter described.

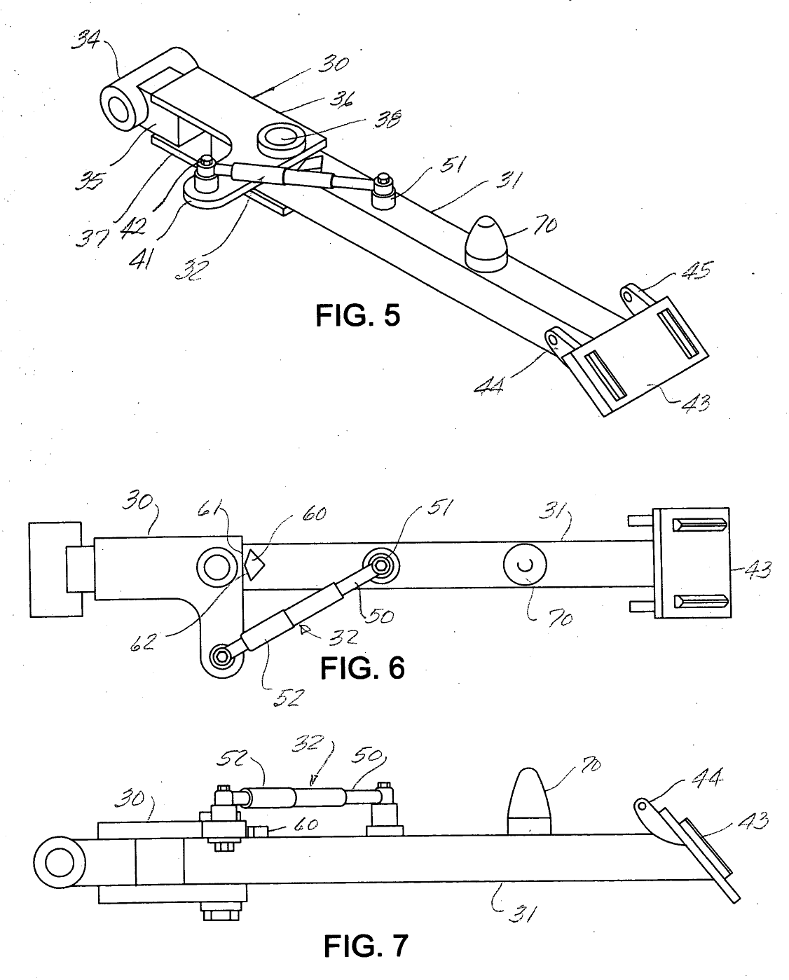

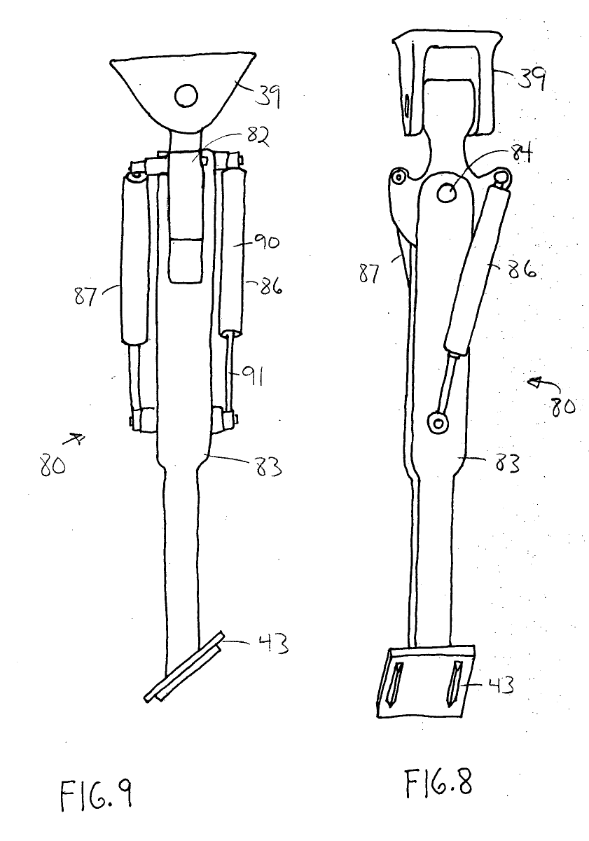

Arm assembly 17 is disposed in depending relation on the underside of the dipper stick, is adapted to cooperate with bucket 13 in grappling articles and further is intended to remain connected to the dipper stick when the machine is performing excavating operations. Generally, it consists of an upper arm section 30, a lower arm section 31, a mechanism 32 for biasing the arm sections into longitudinal alignment below the dipper stick and a collapsible suspension assembly 33. As best shown in FIG. 5 through 6, upper arm section 30 includes a bushing 34 having a radially disposed portion 35, a pair of upper and lower plate portions 36 and 37 and a connecting pin 38. Bushing 34 is pivotally connected to a pair of depending brackets 39, 39 provided on the underside of the dipper stick by means of a connecting pin 40 (See FIG. 1). Upper and lower plate portions 36 and 37 are longitudinally aligned relative to portion 35 and are secured at one set of ends thereto and are connected together in spaced relation at the free ends thereof by connecting pin 38. Upper plate portion 36 further is provided with a laterally projecting segment 41 having a connecting pin 42 provided with an axis displaced radially from the axis of connecting pin 38 and parallel thereto. Lower arm section 31 is of an elongated, box beam construction having one end pivotally connected to connecting pin 38 between upper and lower plate portions 36 and 37, and a free end provided with a pad 43 having a pair of connecting brackets 44 and 45. As best seen in FIGS. 3 and 4, suspension assembly 33 consists of a pair of chains 46 and 47 connected at their upper ends to a pair of depending brackets 48 and 49 provided on the underside of the dipper stick adjacent its free end, and connected at their lower ends to brackets 44 and 45 provided on the pad portion of the lower arm section. The midsections of such chains further are interconnected by a chain 50. While chains are disclosed herein, other systems may be used in lieu of the chains, such as ropes, cables, or other materials having sufficient tensile strength to withstand heavy operations and lifting using assembly 17 in conjunction with curl bucket 13.

Biasing mechanism 32 is essentially comparable to a shock absorber mechanism utilized in the automotive field which functions not only to bias lower arm section 31 in longitudinal alignment with upper arm section 30 beneath the dipper stick so that it will be suitably positioned to cooperate with the bucket to perform grappling operations but to retard the angular displacement of the lower arm section relative to the upper arm section about the axis of connecting pin 38. The mechanism includes a first section 50 pivotally connected to a pin 51 provided on the longitudinal centerline of arm section 31, and a telescopic section 52 pivotally connected at its end to connecting pin 42. Disposed within section 52 and interconnecting sections 50 and 52 is a coil spring which functions to bias lower arm section 31 into longitudinal alignment with upper arm section 30 as shown in FIG. 6. Section 50 further consists of a cylinder filled with a fluid, and section 52 includes piston member having a head portion received within the cylinder portion of section 50. Such head section has a pair of restricted passageways intercommunicating opposite sides of the cylinder, which are provided with one-way valves. Section 50 further is provided with a fluid reservoir communicating with the interior of the cylinder on the base side thereof. Mechanism 32 functions in a manner whereby under normal circumstances when no lateral force is applied to the lower arm section causing it to angularly displace about the axis of connecting pin 38, the spring of the mechanism will bias the lower arm section into longitudinal alignment with the upper arm section as shown in FIG. 6. Upon a lateral force being applied to the lower arm section tending to angularly displace it out of longitudinal alignment with the upper arm section, the coil spring of mechanism 32 will either expand or retract creating a biasing force tending to angularly displace the lower arm section back into longitudinal alignment with the upper arm section. As the lower arm section angularly displaces relative to the upper arm section causing the spring of mechanism 32 to expand or retract, the piston of mechanism 32 will displace relative to the cylinder portion thereof with the restricted openings in the piston head permitting the flow of fluid between the ends of the cylinder. Such flow will be restricted and thus function to retard the biasing action of the spring thereof causing the angular displacement of the lower arm section relative to the upper arm section to be correspondingly retarded. Excess fluid on the base side of the cylinder portion of section 50 will flow into the reservoir thereof and make up fluid is supplied from the reservoir when the piston is displaced in the opposite direction. The operation of biasing mechanism 32 functions not only to bias the lower arm section into longitudinal alignment with the upper arm section but to retard the angular displacement of the lower arm section when either being displaced out of or into longitudinal alignment with the upper arm section.

In the use of the assembly shown in FIGS. 1 and 2 to grapple, transport and deposit a particular article, controls on the machine are operated to position the bucket in an uncurled position and position assembly 33 against the article to be grappled. Suitable controls are then operated to extend rod member 26 and thus curl bucket 13 to grip the object between assembly 33 and bucket 13. With the article thus gripped, further controls are operated to lift the article, swing the front end assembly and then deposit the article at the desired site. When it is desired to operate such front end assembly to excavate, arm assembly 17 is permitted to remain in suspended relation to the dipper stick while the front end assembly is operated to excavate. In this regard, the total length of assembly 17 is made sufficiently short so that when the front end assembly is used for excavating, the free end of assembly 17 will be received within the bucket when the bucket is fully curled so as not to interfere with the excavating operation. FIG. 2 illustrates the manner in which arm assembly 17 may be received in bucket 11 filled with a scoop of material being excavated.

Whether the front end assembly of the machine described is used in an excavating or grappling mode, whenever a lateral force is applied to the lower arm section causing it to angularly displace and thus be longitudinally misaligned with the upper arm section, the coil spring of biasing mechanism 50 will exert a force biasing the lower arm section back into longitudinal alignment with the upper arm section. During the application of such a force or the reaction of the spring biasing force, mechanism 32 will further function to retard the angular displacement of the lower arm section.

To prevent damage to the biasing mechanism upon the application of an extreme lateral force, the lower arm section is provided with a stop 60 provided with angularly displaced abutment surfaces 61 and 62 which are adapted to engage transverse surface of plate portion 36 to limit the angular displacement of the lower arm section relative to the upper arm section in either lateral direction. The lower arm section further is provided with a bumper 70 mounted on the upper side adjacent the free end thereof which is adapted to engage the underside of the dipper stick and thus prevent the lower arm member from striking the underside of the dipper stick.

In an alternative embodiment to the preferred above, a shock absorber may be used in place of the biasing mechanism disclosed above. The coil spring (not shown) that is contained in within section 52 may be dispensed with in the mechanism 32. The lower arm section 31 may then move back into alignment with the upper arm section 30 by means of gravity rather than spring action. The general operation of the components is the same as the previous embodiment so a detailed description will not be repeated. However, the mechanism 32 without the coil spring will retard the movement of the arm section 31 resulting from gravity when the arm section is displaced relative to upper arm section 30.

In another embodiment, a pair of shock absorbers may be used in the assembly, as shown in FIGS. 8 and 9. The assembly 80 comprises a pair of shocks 86 and 87, but otherwise operates in a similar manner to assembly 17. The assembly 80 is pivotally connected to depending brackets 39, 39, which are similar in design and operation to the assembly as shown in the previous embodiments. The assembly 80 comprises an upper arm section 82 and a lower arm section 83. The lower arm section 83 is pivotally connected to upper arm section 82 via a connecting pin 84. The axis of rotation of lower arm section 83 about upper arm section 82 is generally the same as in the previous embodiment, i.e. in a direction to allow for the lower arm section to move away from alignment with the upper arm section when necessary and to move back again wherein the lower arm section 83 is in alignment with the upper arm section 82. The lower arm section has a generally u-shaped upper end which is mounted on either side of the upper arm section 82. Connecting pin 84 extends between the ends of the u-shaped end and through upper arm section 82 to allow for the pivotal movement. At the opposite end of the lower arm section is a pad 43 having similar structure and operation as in the previous embodiments.

The pivotal rotation of the lower arm section 83 with respect to the upper arm section 82 is retarded with the use of a pair shocks 86 and 87 mounted therebetween as shown in the figures. Each shock comprises a cylinder 90 filled with fluid and a rod 91 which telescopically extends into the cylinder operating in a similar manner to a hydraulic shock. Such shocks are known in the art so a detailed description will not be repeated. The movement of the fluid within the shocks retards the expansion and contraction of the shocks and accordingly the movement of the lower and upper arm sections. As in the previous embodiment, the means for biasing the lower section into the alignment with the upper section is gravity due to the location of the assembly 81, however, the shock absorbers retard such movement.

It will be appreciated that the arm assemblies as described are not only effective in maintaining proper alignment for grappling operations but are simple in design permitting them to be inexpensively manufactured and easily mounted on the front end assembly of a machine.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

1. An assembly mountable on the front end of a machine comprising:
a dipper stick operatively connectable to the front end of said machine;
an implement pivotally connected to said dipper stick;
means operatively interconnecting said dipper stick and said implement for pivoting said implement relative to said dipper stick; and
an arm member having an upper section pivotally connect to an underside of said dipper stick for pivotal movement about a first axis substantially parallel to the pivot action of said implement, a lower section connected to said upper section for pivotal movement relative to said upper section about a second axis lying in a plane disposed substantially perpendicular to said first axis, means interconnecting said arm sections for retarding the pivotal movement thereof, and means suspending from the underside of said dipper stick to a free end of said lower arm section, cooperable with said implement when said implement is pivoted toward said suspending means for grappling articles therebetween.

2. An assembly according to claim 1 further including a means for biasing said arm sections into longitudinal alignment with each other below said dipper stick.

3. An assembly according to claim 2 wherein said biasing means comprises a spring.

4. An assembly according to claim 1 wherein said retarding means includes a cylinder filled with a fluid and a piston having a head portion displaceable in said cylinder, provided with restricted passageways therethrough including one-way valves.

5. An assembly according to claim 4 wherein said cylinder includes a chamber communicable with said cylinder fluid.

6. An assembly according to claim 1 including a pair of retarding means for retarding the pivotal movement thereof.

7. An assembly according to claim 1 wherein said retarding means is pivotally connected to said upper arm member at a point displaced from the longitudinal centerline thereof.

8. An assembly according to claim 1 wherein said upper arm member includes a portion projecting laterally of the longitudinal centerline thereof and an end of said retarding means is pivotally connected thereto.

9. An assembly according to claim 1 wherein said lower arm section includes means restricting the angular displacement of said lower arm member relative to said upper arm member.

10. An assembly according to claim 9 wherein said restricting means comprises an abutment having angularly displaced abutment surfaces engageable with said upper arm member to correspondingly restrict the angular displacement of said lower arm section relative to said upper arm section.

11. An assembly according to claim 2 wherein said biasing means and said retarding means comprise a coil spring and a piston and cylinder assembly wherein said spring is connected at one end thereof to said piston and at another end thereof to said cylinder, said cylinder is provided with a fluid and said piston includes a head portion disposed and displaceable within said cylinder, having a pair of restricted passageways intercommunicating opposite sides of said piston head, provided with one-way valves each permitting flow in a direction opposite of the other of said valves.

12. An assembly according to claim 11 wherein said cylinder includes a reservoir communicating with said fluid at a base end of said cylinder.

13. An assembly according to claim 1 wherein said lower arm section is provided with a pad at a free end thereof.

14. An assembly according to claim 1 wherein said lower arm section is provided with a bumper engageable with the underside of said dipper stick.

15. An assembly according to claim 1 wherein said suspending means comprises a chain assembly.

16. An assembly according to claim 1 wherein said implement comprises a bucket capable of curling and uncurling and said arm member has a length permitting the free end thereof to be received within said bucket when said bucket is curled.

17. An assembly according to claim 1 wherein said arm sections have a length permitting the free end thereof to be received in a bucket when said arm assembly is mounted on said dipper stick and a bucket mounted on said dipper stick is curled.

18. An arm assembly mountable on a dipper stick of a machine and cooperable with an implement pivotally connected to said dipper stick for grappling articles between said arm assembly and said implement when said implement is pivoted toward said arm assembly comprising:
an upper arm section pivotally connectable to the underside of said dipper stick for pivotal movement about a first axis substantially parallel to the axis of rotation of said implement;
a lower arm section connected to said upper arm section for pivotal movement relative to said upper arm section about a second axis lying in a plane disposed substantially perpendicular to said first axis when said arm assembly is mounted on said dipper stick;
means interconnecting said arm sections for retarding the biasing action thereof; and
suspension means connected to the free end of said lower arm section and connectable to said dipper stick when said upper arm section is connected to the underside of said dipper stick, cooperable with said implement when said arm member is mounted on said dipper stick and said implement is pivoted toward said suspension means for grappling articles therebetween.

19. An assembly according to claim 18 including a means for biasing said arm sections into longitudinal alignment with each other.

20. An assembly according to claim 19 wherein said biasing means comprises a spring.

21. An assembly according to claim 18 wherein said retarding means includes a cylinder filled with a fluid and a piston having a head portion displaceable in said cylinder, provided with restricted passageways therethrough including one-way valves.

22. An assembly according to claim 21 wherein said cylinder includes a chamber communicable with said cylinder fluid.

23. An assembly according to claim 18 including a pair of retarding means for retarding the pivotal movement thereof.

24. An assembly according to claim 18 wherein said retarding means is pivotally connected to said upper arm section at a point displaced from the longitudinal centerline thereof.

25. An assembly according to claim 18 wherein said upper arm section includes a portion projecting laterally of the longitudinal centerline thereof and an end of said retarding means is pivotally connected thereto.

26. An assembly according to claim 18 wherein said lower arm section including means restricting the angular displacement of said lower arm section relative to said upper arm section.

27. An assembly according to claim 26 wherein said restricting means comprises a stop having angularly displaced abutment surfaces engageable with said upper arm section to correspondingly restrict the angular displacement of said lower arm section relative to said upper arm section.

28. An assembly according to claim 19 wherein said biasing means and said retarding means comprise a coil spring and a piston and cylinder assembly wherein said spring is connected at one end thereof to said piston and at another end thereof to said cylinder, said cylinder is provided with a fluid and said piston includes a head portion disposed and displaceable within said cylinder, having a pair of restricted passageways intercommunicating opposite sides of said piston head, having one-way valves each permitting flow in a direction opposite the direction of flow of the other of said valves.

29. An assembly according to claim 28 wherein said cylinder includes a reservoir communicable with said fluid at a base end of said cylinder.

30. An assembly according to claim 18 wherein said lower arm section is provided with a pad at the free end thereof.

31. An assembly according to claim 18 wherein said lower arm section is provided with a bumper engageable with the underside of said dipper stick when said arm member is mounted on said dipper stick.

32. An assembly according to claim 18 wherein said suspension means comprises a chain assembly.
